(19) United States
(12) Patent Application Publication
(10) Pub. No.: US 2020/0374717 A1
(43) Pub. Date: Nov. 26, 2020

(54) SYNCHRONIZATION SIGNAL BLOCKS FOR BEAM FAILURE DETECTION

(71) Applicant: QUALCOMM Incorporated, San Diego, CA (US)

(72) Inventors: Ruhua He, San Diego, CA (US); Yong Li, San Diego, CA (US); Michael Levitsky, Rehovot (IL); Raghu Narayan Challa, San Diego, CA (US)

(21) Appl. No.: 16/880,946

(22) Filed: May 21, 2020

Related U.S. Application Data
(60) Provisional application No. 62/852,278, filed on May 23, 2019.

(51) Int. Cl. H04W 24/04; H04W 56/00; H04W 16/28

(52) U.S. Cl. CPC H04W 24/04; H04W 16/28; H04W 56/0015

(57) ABSTRACT

Methods, systems, and devices for wireless communications are described. In some cases, a user equipment (UE) may be configured to use certain reference signals to perform radio link monitoring and/or beam failure detection of a communication link. In some cases, the UE may identify a first reference signal configured for the UE and a second reference signal configured for radio link monitoring and/or beam failure detection. In some cases, the UE may determine a synchronization signal block (SSB) for the radio link monitoring or the beam failure detection of the control channel based on an association between the second reference signal and the SSB. For example, the UE may be configured to follow a sequence including hops between different reference signals to arrive at the SSB. The UE may then perform the radio link monitoring and/or the beam failure detection using the SSB.

### CROSS REFERENCE

The present Application for Patent claims the benefit of U.S. Provisional Patent Application No. 62/852,278 by HE et al., entitled “SYNCHRONIZATION SIGNAL BLOCKS FOR BEAM FAILURE DETECTION,” filed May 23, 2019, assigned to the assignee hereof, and expressly incorporated by reference in its entirety.

### BACKGROUND

The following relates generally to wireless communications, and more specifically to synchronization signal blocks (SSBs) for beam failure detection.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code-division multiple access (CDMA), time-division multiple access (TDMA), frequency-division multiple access (FDMA), orthogonal frequency-division multiple access (OFDMA), or discrete Fourier transform spread orthogonal frequency-division multiplexing (DFT-s-OFDM). A wireless multiple-access communications system may include a number of base stations or network access nodes, each simultaneously supporting communication for multiple communications devices, which may be otherwise known as user equipment (UE).

In some wireless communications systems, a UE may be configured to monitor a control channel for control signaling transmitted via a beam from a base station. The UE may be configured to perform radio link monitoring and/or beam failure detection using certain types of signaling (e.g., certain reference signals). Upon detecting a beam failure, for example, the UE may initiate a beam recovery procedure. In some cases, however, the UE may not support using certain types of signaling for such radio link monitoring and/or beam failure detection.

### SUMMARY

The described techniques relate to improved methods, systems, devices, and apparatuses that support synchronization signal blocks (SSBs) for beam failure detection. Generally, the described techniques provide for a user equipment (UE) to trace back from a reference signal associated with a physical channel (e.g., a control channel) to an SSB having a spatial quasi-co-location (QCL) relationship with the physical channel. The UE may use the SSB (e.g., either alone or in combination with the reference signal) to perform radio link monitoring and/or beam failure detection of a communication link between the UE and a base station. Based on detecting a beam failure, for example, the UE may initiate a beam recovery procedure.

In some cases, the UE may identify a first reference signal configured for the UE for a control channel. For example, the base station may transmit tracking reference signals (TRSs) to the UE to facilitate frequency and time tracking for the physical channel. In some cases, the UE may further identify a second reference signal that is configured (e.g., explicitly or implicitly) for radio link monitoring and/or beam failure detection of the control channel. In some cases, however, the UE may not support using the second reference signal for radio link monitoring and/or beam failure detection.

In some cases, reference signals may be associated with other signals according to a configured relationship. Accordingly, the UE may determine an SSB for the radio link monitoring and/or the beam failure detection of the control channel based on the association, for example, according to a relationship between the second reference signal and the SSB. For example, the UE may be configured to follow a sequence (e.g., a tracing sequence) including one or more hops between different reference signals to arrive at the SSB, which the UE has the capability to use to perform the beam failure detection procedure. The UE may then perform the radio link monitoring and/or the beam failure detection using the SSB.

A method of wireless communications at a UE is described. The method may include identifying a first reference signal configured for the UE for a control channel, identifying a second reference signal configured for radio link monitoring or beam failure detection of the control channel, determining, based on the first reference signal being configured for the UE, an SSB for the radio link monitoring or the beam failure detection of the control channel based on a QCL association between the second reference signal and the SSB, and performing the radio link monitoring or the beam failure detection based on the SSB.

An apparatus for wireless communications at a UE is described. The apparatus may include a processor, memory coupled with the processor, and instructions stored in the memory. The instructions may be executable by the processor to cause the apparatus to identify a first reference signal configured for the UE for a control channel, identify a second reference signal configured for radio link monitoring or beam failure detection of the control channel, determine, based on the first reference signal being configured for the UE, an SSB for the radio link monitoring or the beam failure detection of the control channel based on a QCL association between the second reference signal and the SSB, and perform the radio link monitoring or the beam failure detection based on the SSB.

Another apparatus for wireless communications at a UE is described. The apparatus may include means for identifying a first reference signal configured for the UE for a control channel, identifying a second reference signal configured for radio link monitoring or beam failure detection of the control channel, determining, based on the first reference signal being configured for the UE, an SSB for the radio link monitoring or the beam failure detection of the control channel based on a QCL association between the second reference signal and the SSB, and performing the radio link monitoring or the beam failure detection based on the SSB.

A non-transitory computer-readable medium storing code for wireless communications at a UE is described. The code may include instructions executable by a processor to identify a first reference signal configured for the UE for a control channel, identify a second reference signal configured for radio link monitoring or beam failure detection of the control channel, determine, based on the first reference signal being configured for the UE, an SSB for the radio link monitoring or the beam failure detection of the control channel based on a QCL association between the second reference signal and the SSB, and perform the radio link monitoring or the beam failure detection based on the SSB.

In some examples of the method, apparatuses, and non-transitory computer-readable medium described herein, determining the SSB for the radio link monitoring or the beam failure detection may include operations, features, means, or instructions for determining one or more hops for the QCL association. In some examples of the method, apparatuses, and non-transitory computer-readable medium described herein, the one or more hops for the QCL association includes one or more spatial hops between one or more of: a TRS, a channel state information (CSI) reference signal (CSI-RS) configured for beam management, a CSI-RS configured for CSI, or the SSB.

In some examples of the method, apparatuses, and non-transitory computer-readable medium described herein, the UE may be not configured to support radio link monitoring using a CSI-RS, and the determining may be based on the UE not supporting the radio link monitoring or the beam failure detection using the CSI-RS. Some examples of the method, apparatuses, and non-transitory computer-readable medium described herein may further include operations, features, means, or instructions for transmitting a capability message including an indication that the UE may be not configured to support radio link monitoring or beam failure detection using the CSI-RS.

In some examples of the method, apparatuses, and non-transitory computer-readable medium described herein, identifying the second reference signal may include operations, features, means, or instructions for identifying that a configuration for a reference signal for radio link monitoring or beam failure detection of the control channel may have not been received.

In some examples of the method, apparatuses, and non-transitory computer-readable medium described herein, the first reference signal may be configured as a direct QCL source of a control channel. In some examples of the method, apparatuses, and non-transitory computer-readable medium described herein, the first reference signal includes a TRS. In some examples of the method, apparatuses, and non-transitory computer-readable medium described herein, the second reference signal includes a CSI-RS.

Some examples of the method, apparatuses, and non-transitory computer-readable medium described herein may further include operations, features, means, or instructions for receiving an indication of the QCL association in one or more of a radio resource control (RRC) message or a Medium Access Control (MAC) control element (CE).

Some examples of the method, apparatuses, and non-transitory computer-readable medium described herein may further include operations, features, means, or instructions for determining the SSB for the radio link monitoring or the beam failure detection may be based on a duration of a signal metric for the second reference signal satisfying a threshold.

### BRIEF DESCRIPTION OF THE DRAWINGS

FIG. 1 illustrates an example of a wireless communications system that supports synchronization signal blocks (SSBs) for beam failure detection in accordance with aspects of the present disclosure.

FIG. 2 illustrates an example of a wireless communications system that supports SSBs for beam failure detection in accordance with aspects of the present disclosure.

FIG. 3 illustrates an example of a process flow that supports SSBs for beam failure detection in accordance with aspects of the present disclosure.

FIG. 4 illustrates an example of a process flow that supports SSBs for beam failure detection in accordance with aspects of the present disclosure.

FIGS. 5 and 6 show block diagrams of devices that support SSBs for beam failure detection in accordance with aspects of the present disclosure.

FIG. 7 shows a block diagram of a communications manager that supports SSBs for beam failure detection in accordance with aspects of the present disclosure.

FIG. 8 shows a diagram of a system including a device that supports SSBs for beam failure detection in accordance with aspects of the present disclosure.

FIGS. 9 and 10 show flowcharts illustrating methods that support SSBs for beam failure detection in accordance with aspects of the present disclosure.

### DETAILED DESCRIPTION

In some wireless communications systems, a user equipment (UE) may be configured to monitor a control channel for control signaling transmitted via a beam from a base station. The UE may be configured to perform radio link monitoring and/or beam failure detection using certain resources and certain types of signaling (e.g., one or more reference signals, such as UE-specific reference signals and other reference signals for channel estimation, such as channel state information (CSI) reference signals (CSI-RSs)). Radio link monitoring may include the UE monitoring reference signals to determine if a radio link (e.g., for beamformed transmission) has sufficient channel conditions for communications between the UE and the base station. Beam failure detection may include monitoring for criteria that, when met, indicate to the UE that a beam failure has occurred (e.g., that channel conditions for the beam have deteriorated to a point where transmissions via the beam may be unsuccessful). In some cases, upon detecting a beam failure, the UE may initiate a beam recovery procedure.

In some cases, resources for radio link monitoring and/or beam failure detection may not be configured, and the UE may perform these procedures using an implicit (e.g., default) indication for the reference signals. One or more of the reference signals may be, for example, a quasi-co-location (QCL) source for the control channel monitored by the UE for the beam. In some cases, reference signals may be associated via a QCL association to other signals (e.g., synchronization signals and/or other reference signals). A spatial QCL relationship may indicate that signals received from the base station are from spatially co-located or quasi-co-located antennas of the base station (e.g., a same beam or precoding applied from the same antennas). Spatial QCL may allow the UE to assume one or more parameters (e.g., channel properties) that may be shared among transmissions associated by spatial QCL.

In some cases, however, the UE may not support using certain types of signaling for beam failure detection and/or radio link monitoring (e.g., the UE may not support using CSI-RS for beam failure detection). In such cases, techniques provided herein may establish a set of rules for the UE to follow such that the UE may still perform beam failure detection efficiently in these cases. For example, as described herein, the UE may identify a synchronization signal block (SSB) as the root QCL source corresponding to the beam and the UE may use the SSB signal for a particular configuration to perform beam failure detection or radio link monitoring.

In some cases, the UE may be configured to follow a QCL tracing sequence including one or more hops between different reference signals to arrive at a particular reference signal or SSB that the UE has the capability to use to perform the beam failure detection procedure. The QCL tracing sequence may begin at a first reference signal, for example, configured as a UE-specific reference signal (e.g., a tracking reference signal (TRS)). From the first reference signal, the UE may determine a second reference signal to be a QCL source of the first reference signal. In some cases, the UE may continue to associate further source reference signals with the previously determined reference signal according to the QCL tracing sequence, for example, until the UE determines to use the SSB as the QCL source. The UE may then use the determined signal for the SSB to perform beam failure detection and/or radio link monitoring.

Aspects of the disclosure are initially described in the context of a wireless communications system. Examples of process flows are then provided in accordance with some aspects of the disclosure. Aspects of the disclosure are further illustrated by and described with reference to apparatus diagrams, system diagrams, and flowcharts that relate to SSBs for beam failure detection.

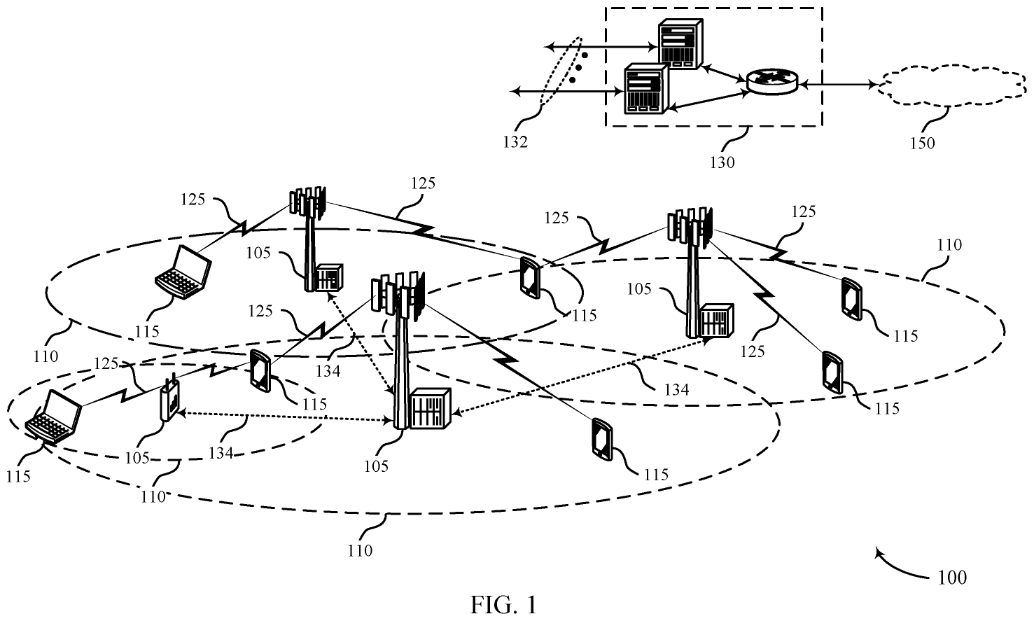

FIG. 1 illustrates an example of a wireless communications system 100 that supports SSBs for beam failure detection in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communications (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communications or MTC may refer to data communication technologies that allow devices to communicate with one another or a base station 105 without human intervention. In some examples, M2M communications or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., mobility management entity (MME), access and mobility management function (AMF)), and at least one user plane entity that routes packets or interconnects to external networks (e.g., serving gateway (S-GW), Packet Data Network (PDN) gateway (P-GW), user plane function (UPF)). The control plane entity may manage non-access stratum (NAS) functions such as mobility, authentication, and bearer management for UEs 115 served by base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency-division duplexing (FDD), time-division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based on listening according to different receive beam directions (e.g., a beam direction determined to have a highest signal strength, highest signal-to-noise ratio, or otherwise acceptable signal quality based on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Ts. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunications system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency-division multiplexing (OFDM) or discrete Fourier transform spread OFDM (DFT-s-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time-division multiplexing (TDM) techniques, frequency-division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may include one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some wireless communications systems 100, a UE 115 may be configured to monitor a control channel for signals for performing radio link monitoring and/or beam failure detection. In some cases, however, the UE 115 may not support using certain types of signaling for such beam failure detection and/or radio link monitoring (e.g., the UE 115 may not support using CSI-RS for beam failure detection). In such cases, techniques provided herein may establish a set of rules for the UE 115 to follow to perform the beam failure detection and/or radio link monitoring. For example, as described herein, the UE may identify an SSB as a source corresponding to the beam and the UE may use the SSB signal for a particular configuration to perform beam failure detection. In some cases, the UE may be configured to follow a tracing sequence (e.g., a QCL tracing sequence) including one or more hops between different reference signals to arrive at a particular signal (e.g., SSB or reference signal) that the UE has the capability to use to perform the beam failure detection procedure.

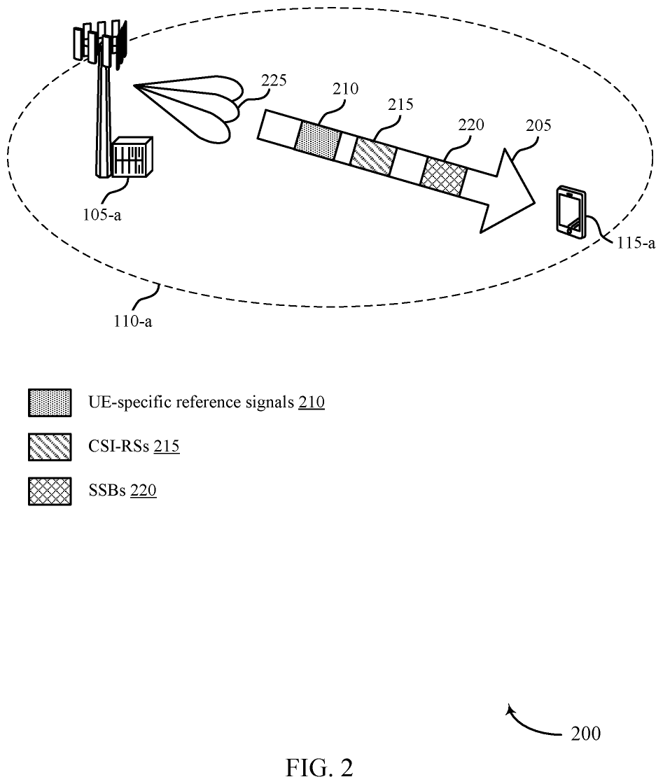

FIG. 2 illustrates an example of a wireless communications system 200 that supports SSBs for beam failure detection in accordance with aspects of the present disclosure. In some examples, the wireless communications system 200 may implement aspects of the wireless communications system 100 as described with reference to FIG. 1. The wireless communications system 200 includes a base station 105-a and a UE 115-a, which may be examples of the corresponding devices as described with reference to FIG. 1. The base station 105-a may provide network coverage for a geographic coverage area 110-a. The base station 105-a may transmit downlink communications to the UE 115-a over a downlink channel 205 including, for example, one or more UE-specific reference signals 210, one or more CSI-RSs 215 (or other reference signals for channel estimation), and one or more SSBs 220. In some cases, the UE 115-a may transmit uplink communications to the base station 105-a over an uplink channel (not shown).

In some wireless communications systems, such as the wireless communications system 200, a UE 115-a may be configured to monitor a control channel via a control resource set (CORESET), which may be transmitted via a beam 225 from the base station 105-a. The UE 115-a may be configured to perform radio link monitoring and/or beam failure detection using certain resources and certain types of signaling (e.g., one or more reference signals, such as UE-specific reference signals 210 and CSI-RSs 215). Radio link monitoring may include the UE 115-a monitoring signals to determine if one or more radio links (e.g., for beamformed transmission) satisfy criteria for communications between the UE 115-a and the base station 105-a. For example, radio link monitoring may include monitoring for events such as the signal strength (e.g., according to a signal-to-noise ratio (SNR), signal-to-interference-plus-noise ratio (SINR), reference signal received power (RSRP), received signal received quality (RSRQ), etc.) becoming greater than or less than various thresholds and/or the signal strength associated with a serving cell falling below the signal strength for one or more neighboring cells, in which case the UE 115-a may report the event or events to the base station 105-a. Beam failure detection may include monitoring for criteria that, when met, indicate to the UE 115-a that a beam failure has occurred (e.g., that channel conditions for the beam have deteriorated to a point where transmissions via the beam may be unsuccessful). In some cases, upon detecting a beam failure, the UE 115-a may initiate a beam recovery procedure.

In cases in which resources for radio link monitoring and/or beam failure detection are not configured, the UE 115-a may use an implicit (e.g., default) association to identify a reference signal to perform these procedures. The reference signal may be, for example, a QCL source for the control channel monitored by the UE 115-a for the beam 225. In some cases, the QCL source may be, for example, a CSI-RS. Reference signals may be associated with QCL relationships to other signals (e.g., synchronization signals, other reference signals), which may at times be referred to herein as a QCL association. For example, QCL relationships may be defined according to one or more of Doppler shift, Doppler spread, average delay, delay spread, spatial QCL, or other like metrics. For example, a spatial QCL relationship may indicate that signals received from the base station 105-a are from spatially co-located or quasi-co-located antennas of the base station 105-a (e.g., a same beam 225 or precoding applied from the same antennas). In some cases, a spatial type of QCL may be referred to as QCL Type D. Spatial QCL may allow the UE 115-a to assume one or more parameters (e.g., channel properties) that may be shared among transmissions associated by spatial QCL.

In some cases, however, the UE 115-a may not support using certain types of signaling for beam failure detection and/or radio link monitoring. For example, the UE 115-a may not support using CSI-RS to perform beam failure detection. In such cases, techniques provided herein may establish a set of rules for the UE 115-a to follow such that the UE 115-a may still perform beam failure detection efficiently in these cases. For example, as described herein, the UE 115-a may identify an SSB 220 as the QCL source corresponding to the beam 225, and the UE 115-a may use the SSB 220 signal for a particular configuration to perform beam failure detection (e.g., according to a transmission configuration indication (TCI) state). In some cases, downlink transmission states may be indicated through downlink TCI states. For example, a TCI state indication may indicate to the UE 115-a the source signals with which a downlink transmission (e.g., physical downlink control channel (PDCCH), CSI-RS, TRS, etc.) may be co-located (or quasi-co-located) in a deployment that utilizes beamforming. In some examples, the downlink TCI state may be signaled in a PDCCH transmission for corresponding physical downlink shared channel (PDSCH) demodulation, and the UE 115-a may use the indication to determine which reference resources are used for delay spread and Doppler and time/frequency offset compensation for PDSCH decoding.

In some cases, the UE 115-a may follow a configured set of rules to identify the SSB 220 to detect a beam failure in a beam failure detection procedure. For example, the UE 115-a may be configured to follow a QCL tracing sequence including one or more hops between different reference signals to arrive at a particular reference signal that the UE 115-a has the capability to use to perform the beam failure detection procedure. In some cases, the QCL tracing sequence may be configured according to a TCI state of the PDCCH (e.g., a QCL source for the PDCCH). The QCL tracing sequence may begin at a first reference signal (e.g., a QCL Type D reference signal for PDCCH), for example, configured as a UE-specific reference signal 210 (e.g., a TRS). From the first reference signal, the UE 115-a may determine a QCL source of the first reference signal (e.g., a QCL Type D source), being a second reference signal.

The UE 115-a may continue to associate further source reference signals with the previously determined reference signal according to the QCL tracing sequence, for example, until the UE 115-a determines to use a signal for the SSB 220 as the QCL source. The UE 115-a may then use the determined signal for the SSB 220, for example, to perform channel estimation on the channel transmitted by the associated antenna of the base station 105-a (e.g., to estimate a SINR of the channel). The UE 115-a may use the channel estimates (e.g., SINR) to further perform beam failure detection and/or radio link monitoring. For example, the UE 115-a may determine that a beam failure has occurred based on a duration of a relatively low SINR exceeding a threshold duration (e.g., indicating a relatively long period of interference or otherwise poor signal conditions).

Examples of QCL tracing sequences are provided herein, according to Tables 1 through 4 shown below. Tables 1 through 4 show example lookup tables for an example configuration for QCL tracing. For Tables 1 through 4, when QCL type D is configured, the TCI states correspond to the downlink reference signal as shown.

TABLE 1
PDCCH/PDSCH

| | Downlink |
|---|---|
| Valid TCI State | Reference |
| Configuration | Signal |
| 1 | TRS |
| 2 | CSI-RS (Beam |
| | Management |
| | (BM)) |
| 3** | CSI-RS (CSI) |
| 4* | SS/PBCH Block |

* May be applied before TRS is configured, although this may not be a valid TCI state, but rather a valid QCL assumption.
** In some cases, QCL parameters may not be derived directly from CSI-RS (CSI).

TABLE 2
TRS

| | Downlink |
|---|---|
| Valid TCI State | Reference |
| Configuration | Signal |
| 1 | TRS |
| 2 | CSI-RS (Beam |
| | Management |
| | (BM)) |

TABLE 3
CSI-RS (CSI)

| | Downlink |
|---|---|
| Valid TCI State | Reference |
| Configuration | Signal |
| 1 | TRS |
| 2 | SS/PBCH Block |
| 3 | CSI-RS (BM) |

TABLE 4
CSI-RS (BM)

| | Downlink |
|---|---|
| | Reference |
| Valid TCI State | Signal 2 (if |
| Configuration | configured) |
| 1 | TRS |
| 2 | CSI-RS (BM) |
| 3 | SS/PBCH Block |

According to a first illustrative example, the UE 115-a may identify a TRS as a first reference signal corresponding to a PDCCH (e.g., TCI state 1 in Table 1). Moving from Table 1 from Table 2 above, the UE 115-a may identify that a QCL source corresponding to the TRS may be the synchronization signal/physical broadcast channel (SS/PBCH) block, for example, according to TCI state 1 of Table 2. Accordingly, in the first illustrative example, the UE 115-a performs one hop, for example, from TRS to the SS/PBCH block to identify an SS/PBCH block for performing a beam failure detection procedure (or radio link management).

According to a second illustrative example, the UE 115-a may identify a CSI-RS configured for BM (notated herein as CSI-RS (BM)) as a first reference signal corresponding to a PDCCH (e.g., TCI state 2 in Table 1). Moving from Table 1 to Table 4 above, the UE 115-a may identify that a QCL source corresponding to the CSI-RS (BM) may, in some cases, be TRS (e.g., TCI state 1 in Table 4). Then, as similarly described in the first illustrative example, the UE 115-a may identify that a QCL source corresponding to the TRS may be the SS/PBCH block, for example, according to TCI state 1 of Table 2. Accordingly, in the second illustrative example, the UE 115-a performs two hops to identify an SS/PBCH block for performing a beam failure detection procedure (or radio link management), including, for example, a first hop from CSI-RS (BM) to TRS and a second hop from TRS to the SS/PBCH block.

According to a third illustrative example, the UE 115-a may identify a CSI-RS configured for CSI (notated herein as CSI-RS (CSI)) as a first reference signal corresponding to a PDCCH (e.g., TCI state 3 in Table 1). Moving from Table 1 from Table 3 above, the UE 115-a may identify that a QCL source corresponding to the CSI-RS (CSI) may, in some cases, be CSI-RS (BM) (e.g., TCI state 3 in Table 3). Then, as similarly described in the second illustrative example, moving from Table 3 to Table 4 above, the UE 115-a may identify that a QCL source corresponding to the CSI-RS (BM) may, in some cases, be TRS (e.g., TCI state 1 in Table 4). Then, as similarly described in the first illustrative example, the UE 115-a may identify that a QCL source corresponding to the TRS may be the SS/PBCH block, for example, according to TCI state 1 of Table 2. Accordingly, in the third illustrative example, the UE 115-a performs three hops to identify an SS/PBCH block for performing a beam failure detection procedure (or radio link management), including, for example, a first hop from CSI-RS (CSI) to CSI-RS (BM), a second hop from CSI-RS (BM) to TRS, and a third hop from TRS to the SS/PBCH block.

In some cases, a periodicity threshold may be defined, where the UE 115-a may compare a periodicity of the reference signal (e.g., the CSI-RS) to the periodicity threshold to determine the SSB 220 for beam failure detection or radio link management. For example, the UE 115-a may determine to use the SSB 220 sharing a special QCL based on a periodicity of the CSI-RS being higher than a threshold (e.g., 40 ms, 80 ms, 160 ms), which may correspond to a periodicity (e.g., or integer multiple of the periodicity) for the SSB 220 (e.g., 20 ms).

According to the techniques described herein, using the SSB 220 as a source SSB 220 for the QCL source for the control channel for beam failure detection or radio link management may provide for relatively reduced complexity of UEs 115 for beam failure detection or radio link management (e.g., complexity in terms of operations required by a processor, hardware requirements, etc.) in the case that the UE 115-a does not support using CSI-RS for beam failure detection or radio link management. Further, in some cases, the UE 115-a may also use the source SSB 220 to relatively increase a sampling rate for beam failure detection. In some cases, the sampling rate may be increased for other signals in addition to the SSB 220. Such increases of sampling rate may increase the reliability of beam failure detection.

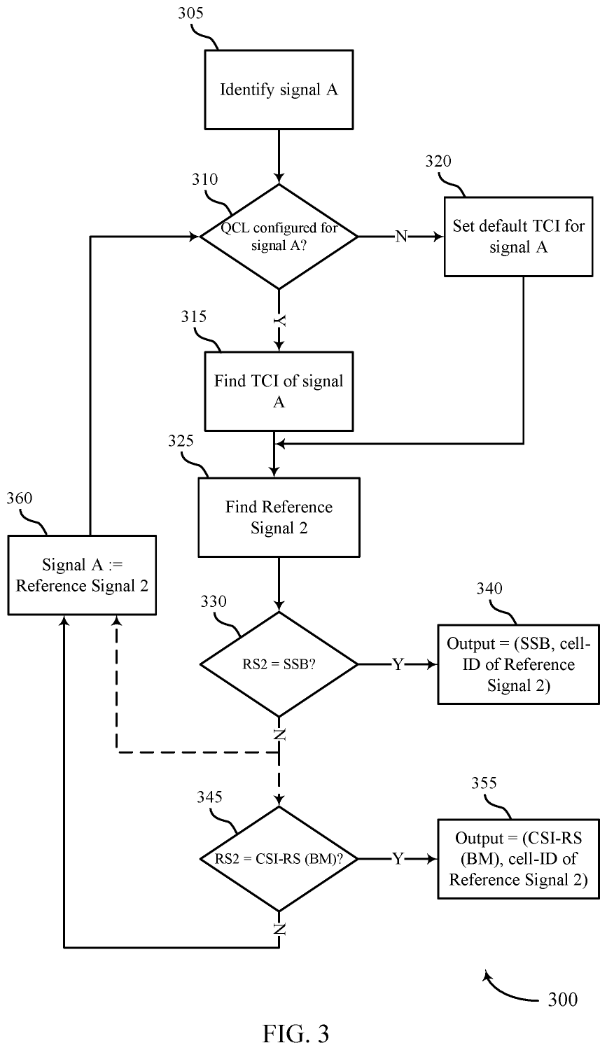

FIG. 3 illustrates an example of a process flow 300 that supports SSBs for beam failure detection in accordance with aspects of the present disclosure. In some examples, the process flow 300 may be implemented by aspects of wireless communications system 100 or 200 including a base station 105 and a UE 115, which may be examples of the corresponding devices described with reference to FIGS. 1 and 2. Alternative examples of the following may be implemented, where some steps are performed in a different order than described or are not performed at all. In some cases, steps may include additional features not mentioned below, or further steps may be added.

At 305, the UE may identify a target signal (e.g., signal A) configured (e.g., explicitly or implicitly) for performing radio link monitoring or beam failure detection. The signal may, for example, be a physical channel (e.g., a control channel or shared channel) or a reference signal associated with a physical channel such as a TRS or CSI-RS for the physical channel.

At 310, the UE may identify whether the UE is configured with a QCL configuration for signal A. For example, example QCL configurations are described with reference to FIG. 2, such as the configurations for QCL tracing shown in Tables 1 through 4.

At 315, if the UE determines that the signal is associated with a QCL configuration, the UE may find a TCI state of signal A (e.g., according to a TCI state indication). For example, a first TCI state indication may enable the UE 115 to know with which reference signals a physical channel (e.g., control channel or shared channel) is co-located (or quasi-co-located) in a deployment that utilizes beamforming. Alternatively, at 320, if the UE determines that signal A is not configured for the QCL configuration, the UE may set a default TCI state for signal A, and the UE may proceed directly to 325. At 325, the UE may find a second reference signal (e.g., Reference Signal 2), for example, according a first hop given by the QCL tracing techniques, as described with reference to FIG. 2.

At 330, the UE may identify whether the second reference signal is an SSB. The SSB may, for example, be identified by an index corresponding to a beam. If so, the UE may proceed to 340 and output an index of the SSB and a cell identifier (ID) of the SSB. The UE may then use the output (e.g., the SSB) to perform radio link monitoring or beam failure detection for signal A (e.g., the beam associated with signal A). If not, the UE may proceed to 360, where the UE may assign the second reference signal as the new target signal (e.g., a new value for signal A), and the UE may return to 310 to identify whether the target signal (e.g., the second reference signal) is associated with a QCL configuration. The UE may then repeat some or all of steps 310, 315, 320, 325, and 330 until the UE identified the second reference signal to be an SSB.

Additionally or alternatively, if the UE supports radio link monitoring or beam failure detection using a different signal (e.g., CSI-RS (BM), as described with reference to FIG. 2), the UE may determine that it may not trace back to an SSB, and the UE may identify an alternative signal at 345. If the UE identifies the alternative signal, for example, the UE may output the alternative signal (e.g., CSI-RS (BM)) at 355 with a corresponding cell ID for the alternative signal. If the UE does not identify the alternative signal (e.g., CSI-RS (BM)), the UE may proceed to 360, where the UE may assign the second reference signal as the new target signal (e.g., a new value for signal A). As similarly described above, the UE may return to 310 to identify whether the target signal (e.g., the second reference signal) is associated with a QCL configuration. The UE may then repeat some or all of steps 310, 315, 320, 325, and 330. Accordingly, the UE may search for a new signal based on identifying the second reference signal not to be the SSB, or the UE may search for a new signal based on identifying the second reference signal not to be the SSB or the alternative signal.

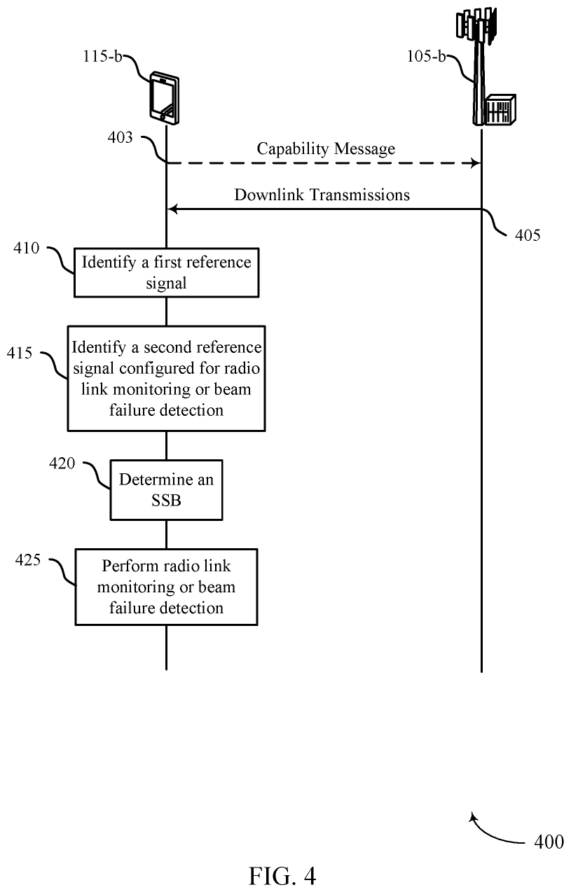

FIG. 4 illustrates an example of a process flow 400 that supports SSBs for beam failure detection in accordance with aspects of the present disclosure. In some examples, the process flow 400 may be implemented by aspects of wireless communications system 100 or 200, as described with reference to FIGS. 1 and 2, respectively. The process flow 400 may include a base station 105-b and a UE 115-b, which may be examples of the corresponding devices described with reference to FIGS. 1 and 2. In some cases, the process flow 300 may implement aspects of the process flow 300 as described with reference to FIG. 3. Alternative examples of the following may be implemented, where some steps are performed in a different order than described or are not performed at all. In some cases, steps may include additional features not mentioned below, or further steps may be added.

At 403, in some cases, the UE 115-b may transmit to the base station 105-b, and the base station 105-b may receive from the UE 115-b, a capability message including an indication of the capabilities of the UE. The UE may indicate in the capability message whether the UE 115-b is capable of supporting radio link monitoring or beam failure detection using CSI-RS. For example, the UE may indicate in the capability message that the UE 115-b is not configured to support radio link monitoring or beam failure detection using CSI-RS.

At 405, the base station 105-b may transmit to the UE 115-b, and the UE 115-b may receive from the base station 105-b, one or more downlink transmissions. In some cases, the downlink transmissions may include, for example, one or more reference signals, data transmissions, control signaling and the like. In some cases, the base station 105-b may transmit the downlink transmissions to the UE 115-b based on the capability message that the base station 105-b may have received from the UE 115-b at 403. In some cases, the downlink transmissions may include an indication of a QCL association, for example, an RRC message or a MAC control element (CE). It is to be understood that while the downlink transmissions are shown only at the step 405, the downlink transmissions may be communicated at a variety of times using different time resources, and may be communicated before or after other steps of the process flow 400.

At 410, the UE 115-b may identify a first reference signal configured for the UE for a control channel (including, e.g., a TRS). For example, once the first reference signal is configured for the UE, the UE may switch from performing radio link monitoring and beam failure detection using an SSB to performing radio link monitoring and beam failure detection for a physical channel (e.g., control channel) associated with the first reference signal. In some cases, the UE 115-b may have received the first reference signal in the downlink transmissions received at 405. In some cases, the first reference signal may be configured as a direct QCL source of a control channel.

At 415, the UE 115-b may identify a second reference signal configured for radio link monitoring or beam failure detection of the control channel (including, e.g., a CSI-RS). In some cases, the second reference signal may be an SSB, or, in other cases, the second reference signal may be an alternative reference signal (e.g., CSI-RS). In some cases, the second reference signal may be the same as the first reference signal (e.g., TRS). In some cases, the UE 115-b may have received the second reference signal in the downlink transmissions received at 405. In some cases, identifying the second reference signal may include identifying that a configuration for a reference signal for radio link monitoring or beam failure detection of the control channel has not been received.

At 420, the UE 115-b may determine, based on the first reference signal being configured for the UE, an SSB for the radio link monitoring or the beam failure detection of the control channel based on a QCL association between the second reference signal and the SSB (e.g., as may have been received in the downlink transmissions at 405). In some cases, determining the SSB for the radio link monitoring or the beam failure detection may include determining one or more hops for the QCL association (e.g., according to a configuration for QCL tracing). That is, according to QCL tracing configurations, the UE 115-b may determine that the second reference signal (e.g., as the UE 115-b may have identified at 415) is the SSB. Alternatively, the UE 115-b may determine one or more additional hops according to a QCL tracing configuration and determine that the SSB is, for example, a further (e.g., third or fourth, etc.) reference signal.

In some cases, the UE 115-b may not be configured to support radio link monitoring using certain reference signals. such as CSI-RS. Accordingly, determining the SSB may be based on the UE 115-b not supporting the radio link monitoring or the beam failure detection using the CSI-RS. In some cases, the UE 115-b may be configured to follow a QCL tracing sequence including one or more hops between different reference signals to arrive at a particular reference signal that the UE 115-b has a capability to use to perform the beam failure detection procedure. In some cases, the QCL tracing sequence may be configured according to a TCI state of the PDCCH (QCL source for the PDCCH). In some cases, the one or more hops may include one or more spatial hops between one or more of: a TRS, a CSI-RS configured for beam management, a CSI-RS configured for CSI, or the SSB. In some cases, determining the SSB for the radio link monitoring or the beam failure detection may be based on a duration of a signal metric (e.g., SINR, among other like signal and channel quality metrics) for the second reference signal satisfying or exceeding a threshold (e.g., a duration of interference and/or poor channel conditions exceeds a threshold duration).

At 425, the UE 115-b may perform the radio link monitoring or the beam failure detection based on the SSB, as may have been determined at 420.

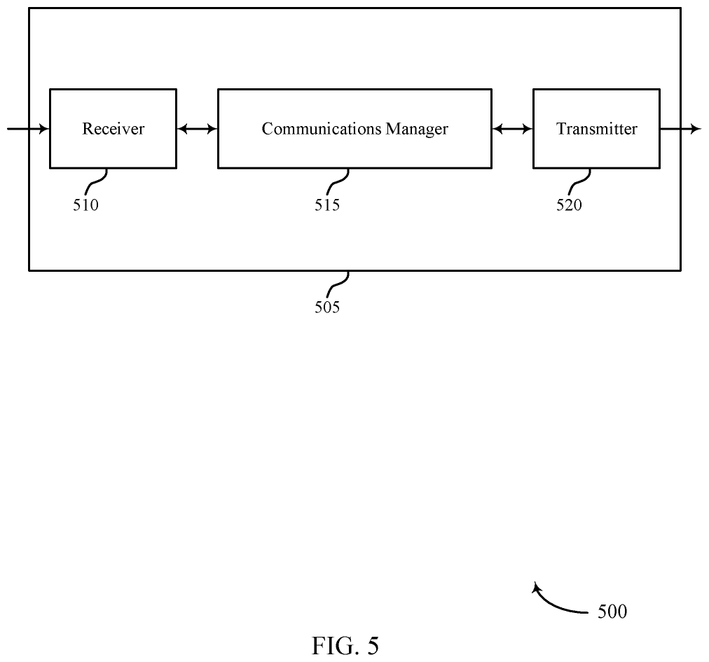

FIG. 5 shows a block diagram 500 of a device 505 that supports SSBs for beam failure detection in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

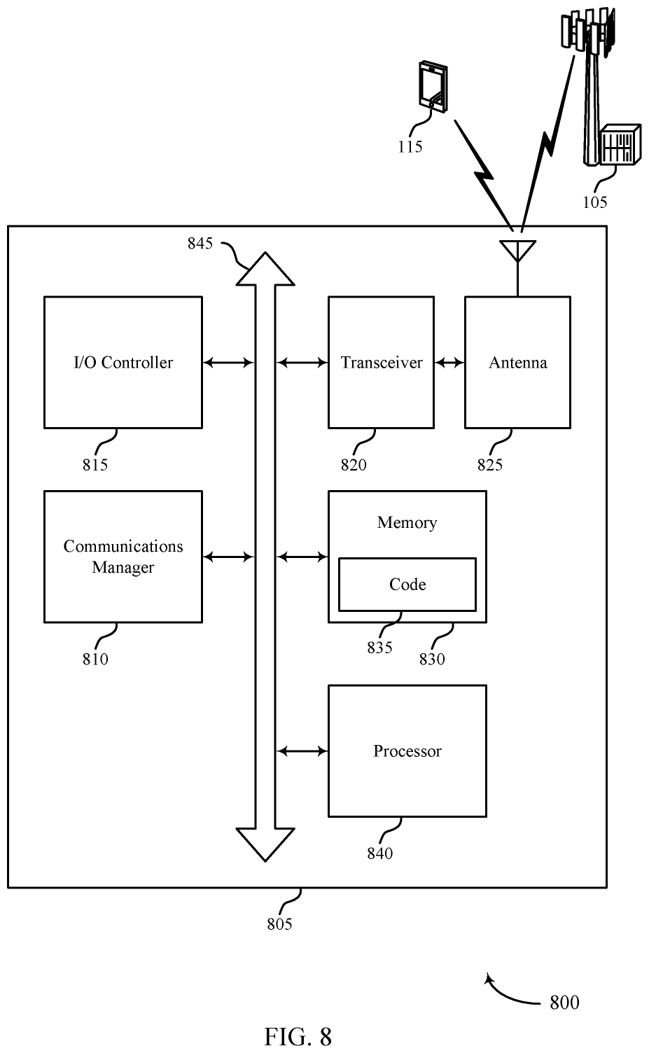

The receiver 510 may receive information such as packets, user data, or control information associated with various information channels (e.g., control channels, data channels, and information related to SSBs for beam failure detection, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may identify a first reference signal configured for the UE for a control channel, identify a second reference signal configured for radio link monitoring or beam failure detection of the control channel, determine, based on the first reference signal being configured for the UE, an SSB for the radio link monitoring or the beam failure detection of the control channel based on a QCL association between the second reference signal and the SSB, and perform the radio link monitoring or the beam failure detection based on the SSB. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

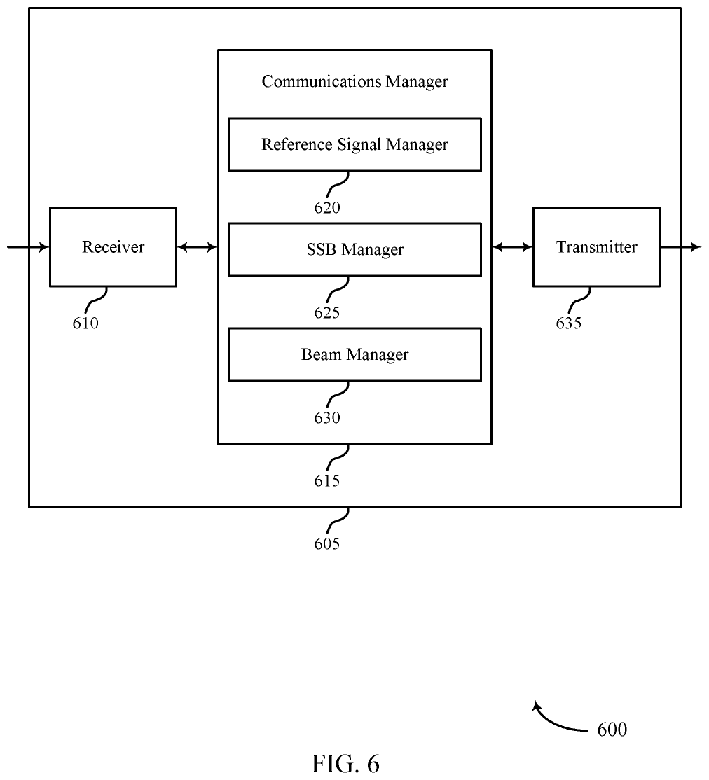

FIG. 6 shows a block diagram 600 of a device 605 that supports SSBs for beam failure detection in accordance with aspects of the present disclosure. The device 605 may be an example of aspects of a device 505, or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to SSBs for beam failure detection, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a reference signal manager 620, an SSB manager 625, and a beam manager 630. The communications manager 615 may be an example of aspects of the communications manager 810 described herein.

The reference signal manager 620 may identify a first reference signal configured for the UE for a control channel and identify a second reference signal configured for radio link monitoring or beam failure detection of the control channel.

The SSB manager 625 may determine, based on the first reference signal being configured for the UE, an SSB for the radio link monitoring or the beam failure detection of the control channel based on a QCL association between the second reference signal and the SSB.

The beam manager 630 may perform the radio link monitoring or the beam failure detection based on the SSB.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

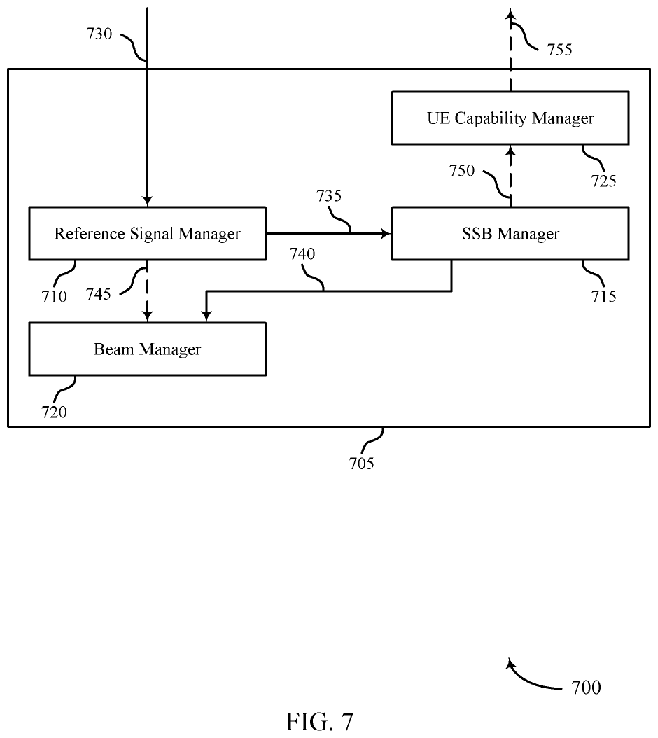

FIG. 7 shows a block diagram 700 of a communications manager 705 that supports SSBs for beam failure detection in accordance with aspects of the present disclosure. The communications manager 705 may be an example of aspects of a communications manager 515, a communications manager 615, or a communications manager 810 described herein. The communications manager 705 may include a reference signal manager 710, an SSB manager 715, a beam manager 720, and a UE capability manager 725. Each of these modules may communicate, directly or indirectly, with one another (e.g., via one or more buses).

The reference signal manager 710 may identify, for a control channel, a first reference signal configured for a UE (e.g., a UE, or other receiving device, including the communications manager 705, as similarly shown and described with reference to FIGS. 5, 6, and 8). For example, the reference signal manager 710 may receive (e.g., from a base station or other transmitting device) one or more signals 730 via a transceiver (e.g., as described with reference to FIG. 8) including information for the first reference signal. In some examples, the first reference signal (e.g., received via the signals 730) may be configured as, or include, a direct QCL source of a control channel. In some examples, the first reference signal may include a TRS. In some examples, the second reference signal may include a CSI-RS. In some examples, the reference signal manager 710 may pass information 735 to the SSB manager 715, where the information 735 may include one or more information bits indicating the first reference signal.

In some examples, the reference signal manager 710 may identify a second reference signal configured for radio link monitoring or beam failure detection of the control channel. In some examples, the signals 730 may additionally include information for the second reference signal, and the reference signal manager 710 may pass information 735 to the SSB manager 715 indicating the second reference signal.

In some examples, the reference signal manager 710 may identify that a configuration for a reference signal for radio link monitoring or beam failure detection of the control channel has not been received. In such examples, the reference signal manager 710 may pass information 735 to the SSB manager 715 indicating that the configuration for the reference signal for radio link monitoring or beam failure detection has not been received.

In some examples, the SSB manager 715 may receive the information 735 from the reference signal manager 710, for example, indicating the first reference signal. In some examples, the information 735 may additionally indicate the second reference signal and/or that the configuration for the reference signal for radio link monitoring or beam failure detection has not been received at the reference signal manager 710. The SSB manager 715 may determine, based on the first reference signal being configured for the UE (e.g., based on the information 735), an SSB for the radio link monitoring or the beam failure detection of the control channel based on a QCL association between the second reference signal and the SSB. In some examples, the SSB manager 715 may receive (e.g., in the information 735 from the reference signal manager 710) an indication of the QCL association, where, for example, one of more of the signals 730 may include one or more of an RRC message or a MAC CE.

In some examples, the SSB manager 715 may determine one or more hops for the QCL association. In some examples, the one or more hops for the QCL association may include one or more spatial hops between one or more of: a TRS, a CSI-RS configured for beam management, a CSI-RS configured for CSI, or the SSB. In some examples, the SSB manager 715 may determine the SSB for the radio link monitoring or the beam failure detection based on a duration of a signal metric for the second reference signal satisfying a threshold (e.g., a threshold duration of a configured period of time).

In some examples, the SSB manager 715 may pass information 740 to the beam manager 720, where the information 740 may include one or more information bits indicating the SSB for the radio link monitoring or the beam failure detection. In some examples, the beam manager 720 may receive the information 740 from the SSB manager 715, and the beam manager 720 may perform the radio link monitoring or the beam failure detection based on the SSB for the radio link monitoring or the beam failure detection (e.g., according to the information 740 received from the SSB manager 715).

In some examples, such as for radio link monitoring, the beam manager 720 may monitor reference signals (e.g., received via one or more signals 730) to determine if a radio link (e.g., for beamformed transmission) has sufficient channel conditions for communications between the UE and the base station. For example, the reference signal manager 710 may pass information 745 to the beam manager 720, where the information 745 may include one or more information bits indicating one or more metrics and/or other signal characteristics relating to the reference signals (e.g., received via one or more signals 730). The beam manager 720 may monitor the information 745 and, based on the metrics and/or signal characteristics indicated in the information 745, determine whether the radio link has sufficient channel conditions for communications between the UE and the base station (e.g., corresponding to the SSB indicated in the information 745).

In some examples, such as for beam failure detection, the beam manager 720 may monitor for criteria that, when met, indicate to the UE that a beam failure has occurred (e.g., that channel conditions for the beam have deteriorated to a point where transmissions via the beam may be unsuccessful). For example, the reference signal manager 710 may include to the beam manager 720 in the information 745 one or more information bits indicating one or more metrics and/or other signal characteristics relating to the criteria for beam failure. The beam manager 720 may monitor the information 745 and, based on the metrics and/or signal characteristics indicated in the information 745, determine whether a beam failure has occurred (e.g., corresponding to the SSB indicated in the information 745).

In some examples, the UE may not be configured to support radio link monitoring using a CSI-RS, and the SSB manager 715 may determine the SSB based on the UE not supporting the radio link monitoring or the beam failure detection using the CSI-RS. In such examples, the SSB manager 715 may pass information 750 to the UE capability manager 725 indicating that the UE does not support the radio link monitoring or the beam failure detection using the CSI-RS. In some examples, the UE capability manager 725 may receive the information 750 from the SSB manager 715. In some examples, the UE capability manager 725 may transmit a capability message including an indication that the UE is not configured to support radio link monitoring or beam failure detection using the CSI-RS. For example, according to the information 750 indicating that the UE does not support the radio link monitoring or the beam failure detection using the CSI-RS, the UE capability manager 725 may transmit (e.g., to the base station) one or more signals 755 via a transceiver (e.g., as described with reference to FIG. 8) including information indicating the capability message.

FIG. 8 shows a diagram of a system 800 including a device 805 that supports SSBs for beam failure detection in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may identify a first reference signal configured for the UE for a control channel, identify a second reference signal configured for radio link monitoring or beam failure detection of the control channel, determine, based on the first reference signal being configured for the UE, an SSB for the radio link monitoring or the beam failure detection of the control channel based on a QCL association between the second reference signal and the SSB, and perform the radio link monitoring or the beam failure detection based on the SSB.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting SSBs for beam failure detection).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

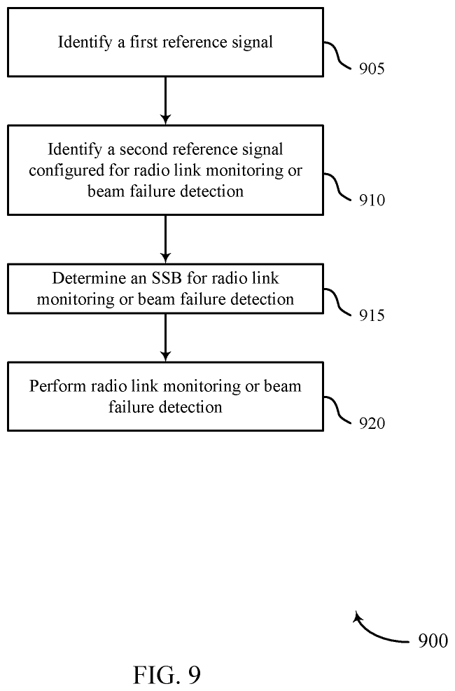

FIG. 9 shows a flowchart illustrating a method 900 that supports SSBs for beam failure detection in accordance with aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 905, the UE may identify a first reference signal configured for the UE for a control channel. For example, the UE may identify time-frequency resources over which the first reference signal may be communicated and receive the first reference signal over the time-frequency resources. The UE may demodulate the first reference signal over the time-frequency resources and decode the demodulated transmission to obtain bits that indicate the first reference signal. The operations of 905 may be performed according to the methods described herein. In some examples, aspects of the operations of 905 may be performed by a reference signal manager as described with reference to FIGS. 5 through 8.

At 910, the UE may identify a second reference signal configured for radio link monitoring or beam failure detection of the control channel. For example, the UE may identify time-frequency resources over which the second reference signal may be communicated. In some examples, the UE may receive the second reference signal over the time-frequency resources, demodulate the second reference signal over the time-frequency resources, and decode the demodulated transmission to obtain bits that indicate the second reference signal. The operations of 910 may be performed according to the methods described herein. In some examples, aspects of the operations of 910 may be performed by a reference signal manager as described with reference to FIGS. 5 through 8.

At 915, the UE may determine an SSB for radio link monitoring or beam failure detection. For example, based on the first reference signal being configured for the UE, the UE may determine the SSB for the radio link monitoring or the beam failure detection of the control channel based on a QCL association between the second reference signal and the SSB. In some cases, the UE may determine that the second reference signal is the SSB. In other cases, the UE may determine that the SSB is another reference signal. The operations of 915 may be performed according to the methods described herein. In some examples, aspects of the operations of 915 may be performed by an SSB manager as described with reference to FIGS. 5 through 8.

At 920, the UE may perform the radio link monitoring or the beam failure detection based on the SSB. For example, the UE may determine if a radio link with the base station has sufficient channel conditions for communications between the UE and the base station. Additionally or alternatively, the UE may monitor channel metrics to determine whether a beam failure has occurred (e.g., that channel conditions for the beam have deteriorated to a point where transmissions via the beam may be unsuccessful). In some cases, upon detecting a beam failure, the UE may initiate a beam recovery procedure. The operations of 920 may be performed according to the methods described herein. In some examples, aspects of the operations of 920 may be performed by a beam manager as described with reference to FIGS. 5 through 8.

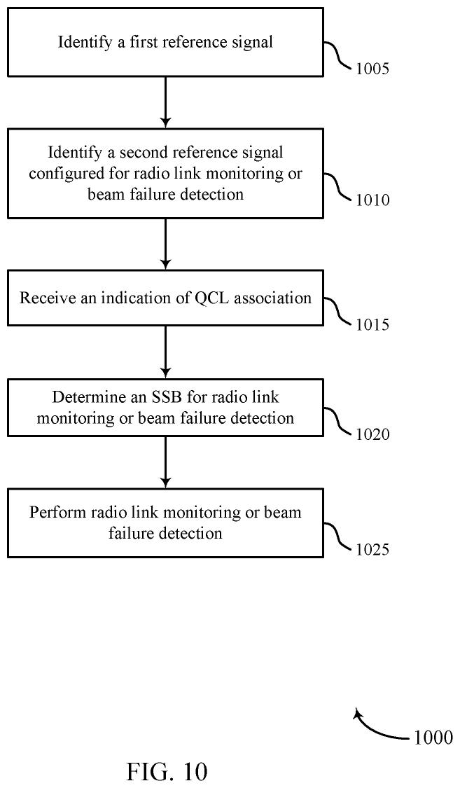

FIG. 10 shows a flowchart illustrating a method 1000 that supports SSBs for beam failure detection in accordance with aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1005, the UE may identify a first reference signal configured for the UE for a control channel. For example, the UE may identify time-frequency resources over which the first reference signal may be communicated and receive the first reference signal over the time-frequency resources. The UE may demodulate the first reference signal over the time-frequency resources and decode the demodulated transmission to obtain bits that indicate the first reference signal. The operations of 1005 may be performed according to the methods described herein. In some examples, aspects of the operations of 1005 may be performed by a reference signal manager as described with reference to FIGS. 5 through 8.

At 1010, the UE may identify a second reference signal configured for radio link monitoring or beam failure detection of the control channel. For example, the UE may identify time-frequency resources over which the second reference signal may be communicated. In some examples, the UE may receive the second reference signal over the time-frequency resources, demodulate the second reference signal over the time-frequency resources, and decode the demodulated transmission to obtain bits that indicate the second reference signal. The operations of 1010 may be performed according to the methods described herein. In some examples, aspects of the operations of 1010 may be performed by a reference signal manager as described with reference to FIGS. 5 through 8.

At 1015, the UE may receive an indication of the QCL association in one or more of an RRC message or a MAC CE. For example, the UE may identify time-frequency resources over which the RRC message and/or the MAC CE including the indication of the QCL association may be communicated, demodulate the RRC message and/or the MAC CE over the time-frequency resources, and decode the demodulated transmission to obtain bits that indicate the QCL association. The operations of 1015 may be performed according to the methods described herein. In some examples, aspects of the operations of 1015 may be performed by an SSB manager as described with reference to FIGS. 5 through 8.

At 1020, the UE may determine, based on the first reference signal being configured for the UE, an SSB for the radio link monitoring or the beam failure detection of the control channel based on a QCL association between the second reference signal and the SSB. For example, based on the first reference signal being configured for the UE, the UE may determine the SSB for the radio link monitoring or the beam failure detection of the control channel based on a QCL association between the second reference signal and the SSB. The operations of 1020 may be performed according to the methods described herein. In some examples, aspects of the operations of 1020 may be performed by an SSB manager as described with reference to FIGS. 5 through 8.

At 1025, the UE may perform the radio link monitoring or the beam failure detection based on the SSB. For example, the UE may determine if a radio link with the base station has sufficient channel conditions for communications between the UE and the base station. Additionally or alternatively, the UE may monitor channel metrics to determine whether a beam failure has occurred (e.g., that channel conditions for the beam have deteriorated to a point where transmissions via the beam may be unsuccessful). In some cases, upon detecting a beam failure, the UE may initiate a beam recovery procedure. The operations of 1025 may be performed according to the methods described herein. In some examples, aspects of the operations of 1025 may be performed by a beam manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code-division multiple access (CDMA), time-division multiple access (TDMA), frequency-division multiple access (FDMA), orthogonal frequency-division multiple access (OFDMA), single carrier frequency-division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), E-UTRA, Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
identifying a first reference signal configured for the UE for a control channel;
identifying a second reference signal configured for radio link monitoring or beam failure detection of the control channel;
determining, based at least in part on the first reference signal being configured for the UE, a synchronization signal block (SSB) for the radio link monitoring or the beam failure detection of the control channel based at least in part on a quasi-co-location association between the second reference signal and the SSB; and
performing the radio link monitoring or the beam failure detection based at least in part on the SSB.

2. The method of claim 1, wherein:
determining the SSB for the radio link monitoring or the beam failure detection comprises determining one or more hops for the quasi-co-location association.

3. The method of claim 2, wherein the one or more hops for the quasi-co-location association comprises one or more spatial hops between one or more of: a tracking reference signal, a channel state information (CSI) reference signal (CSI-RS) configured for beam management, a CSI-RS configured for CSI, or the SSB.

4. The method of claim 1, wherein the UE is not configured to support radio link monitoring using a channel state information (CSI) reference signal (CSI-RS), and the determining is based at least in part on the UE not supporting the radio link monitoring or the beam failure detection using the CSI-RS.

5. The method of claim 4, further comprising:
transmitting a capability message comprising an indication that the UE is not configured to support radio link monitoring or beam failure detection using the CSI-RS.

6. The method of claim 1, wherein identifying the second reference signal comprises:
identifying that a configuration for a reference signal for radio link monitoring or beam failure detection of the control channel has not been received.

7. The method of claim 1, wherein the first reference signal is configured as a direct quasi-co-location source of a control channel.

8. The method of claim 1, wherein the first reference signal comprises a tracking reference signal.

9. The method of claim 1, wherein the second reference signal comprises a channel state information (CSI) reference signal (CSI-RS).

10. The method of claim 1, wherein the second reference signal comprises the SSB.

11. The method of claim 1, further comprising:
receiving an indication of the quasi-co-location association in one or more of a radio resource control (RRC) message or a Media Access Control (MAC) control element (CE).

12. The method of claim 1, wherein:
determining the SSB for the radio link monitoring or the beam failure detection is based at least in part on a duration of a signal metric for the second reference signal satisfying a threshold.

13. An apparatus for wireless communications at a user equipment (UE), comprising:
a processor,
memory coupled with the processor; and
instructions stored in the memory and executable by the processor to cause the apparatus to:
identify a first reference signal configured for the UE for a control channel;
identify a second reference signal configured for radio link monitoring or beam failure detection of the control channel;
determine, based at least in part on the first reference signal being configured for the UE, a synchronization signal block (SSB) for the radio link monitoring or the beam failure detection of the control channel based at least in part on a quasi-co-location association between the second reference signal and the SSB; and
perform the radio link monitoring or the beam failure detection based at least in part on the SSB.

14. The apparatus of claim 13, wherein the instructions to determine the SSB for the radio link monitoring or the beam failure detection are executable by the processor to cause the apparatus to determine one or more hops for the quasi-co-location association.

15. The apparatus of claim 14, wherein the one or more hops for the quasi-co-location association comprises one or more spatial hops between one or more of: a tracking reference signal, a channel state information (CSI) reference signal (CSI-RS) configured for beam management, a CSI-RS configured for CSI, or the SSB.

16. The apparatus of claim 13, wherein the UE is not configured to support radio link monitoring using a channel state information (CSI) reference signal (CSI-RS), and the determining is based at least in part on the UE not supporting the radio link monitoring or the beam failure detection using the CSI-RS.

17. The apparatus of claim 16, wherein the instructions are further executable by the processor to cause the apparatus to:
transmit a capability message comprising an indication that the UE is not configured to support radio link monitoring or beam failure detection using the CSI-RS.

18. The apparatus of claim 13, wherein the instructions to identify the second reference signal are executable by the processor to cause the apparatus to:
identify that a configuration for a reference signal for radio link monitoring or beam failure detection of the control channel has not been received.

19. The apparatus of claim 13, wherein the first reference signal is configured as a direct quasi-co-location source of a control channel.

20. The apparatus of claim 13, wherein the first reference signal comprises a tracking reference signal.

21. The apparatus of claim 13, wherein the second reference signal comprises a channel state information (CSI) reference signal (CSI-RS).

22. The apparatus of claim 13, wherein the instructions are further executable by the processor to cause the apparatus to:
receive an indication of the quasi-co-location association in one or more of a radio resource control (RRC) message or a Media Access Control (MAC) control element (CE).

23. The apparatus of claim 13, wherein determining the SSB for the radio link monitoring or the beam failure detection is based at least in part on a duration of a signal metric for the second reference signal satisfying a threshold.

24. An apparatus for wireless communications at a user equipment (UE), comprising:
means for identifying a first reference signal configured for the UE for a control channel;
means for identifying a second reference signal configured for radio link monitoring or beam failure detection of the control channel;
means for determining, based at least in part on the first reference signal being configured for the UE, a synchronization signal block (SSB) for the radio link monitoring or the beam failure detection of the control channel based at least in part on a quasi-co-location association between the second reference signal and the SSB; and
means for performing the radio link monitoring or the beam failure detection based at least in part on the SSB.

25. The apparatus of claim 24, wherein the means for determining the SSB for the radio link monitoring or the beam failure detection comprises means for determining one or more hops for the quasi-co-location association.

26. The apparatus of claim 24, wherein the UE is not configured to support radio link monitoring using a channel state information (CSI) reference signal (CSI-RS), and the determining is based at least in part on the UE not supporting the radio link monitoring or the beam failure detection using the CSI-RS.

27. The apparatus of claim 24, wherein the means for identifying the second reference signal comprises:
means for identifying that a configuration for a reference signal for radio link monitoring or beam failure detection of the control channel has not been received.

28. A non-transitory computer-readable medium storing code for wireless communications at a user equipment (UE), the code comprising instructions executable by a processor to:
identify a first reference signal configured for the UE for a control channel;
identify a second reference signal configured for radio link monitoring or beam failure detection of the control channel;
determine, based at least in part on the first reference signal being configured for the UE, a synchronization signal block (SSB) for the radio link monitoring or the beam failure detection of the control channel based at least in part on a quasi-co-location association between the second reference signal and the SSB; and
perform the radio link monitoring or the beam failure detection based at least in part on the SSB.

29. The non-transitory computer-readable medium of claim 28, wherein the instructions to determine the SSB for the radio link monitoring or the beam failure detection are executable by the processor to cause the apparatus to determine one or more hops for the quasi-co-location association.

30. The non-transitory computer-readable medium of claim 28, wherein the UE is not configured to support radio link monitoring using a channel state information (CSI) reference signal (CSI-RS), and the determining is based at least in part on the UE not supporting the radio link monitoring or the beam failure detection using the CSI-RS.
